(19) United States
(12) Patent Application Publication
(10) Pub. No.: US 2015/0069107 A1
(43) Pub. Date: Mar. 12, 2015

(54) Method For Controlling Feeding Length Of Wire And Displacement Sensing System For The Same

(71) Applicants: Tyco Electronics Corporation, Berwyn, PA (US); Shenzhen Shengli Jingji Tech Co., Ltd.,, Shenzhen (CN)

(72) Inventors: Roberto Francisco-Yi Lu, Bellevue, WA (US); Qinglong Zeng, Shenzhen (CN)

(73) Assignees: SHENZHEN SHENGLI JINGJI TECH CO. LTD.,, Shenzhen City (CN); TYCO ELECTRONICS CORPORATION, Berwyn, PA (US)

(21) Appl. No.: 14/457,615

(22) Filed: Aug. 12, 2014

(30) Foreign Application Priority Data
Aug. 12, 2013 (CN) 2013103492874

(51) Int. Cl. B23K 3/06

(52) U.S. Cl. CPC B23K 3/063
USPC 226/8; 226/45

(57) ABSTRACT

A method for controlling a feeding length of a wire is provided. The wire is frictionally engaged with and fed by a driving wheel mounted on a driver. The method comprises steps of: providing a displacement sensing device comprising a driven wheel and a sensor for sensing the number of revolutions of the driven wheel, the driven wheel being frictionally engaged with the wire and configured to be rotated under a frictional engaging force therebetween as the wire is fed; starting the driver to rotate the driving wheel, so that the wire is fed forward and the driven wheel is rotated as the wire is fed; calculating an actual feeding length of the wire based on the product of the number of revolutions of the driven wheel sensed by the sensor and the perimeter of the driven wheel; and controlling the feeding length of the wire based on an error between a predetermined feeding length of the wire and the calculated actual feeding length of the wire with closed loop feedback control until the error becomes zero or within an allowable range.

### CROSS-REFERENCE TO RELATED APPLICATION

This application claims the benefit of Chinese Patent Application No. 201310349287.4 filed on Aug. 12, 2013 in the State Intellectual Property Office of China.

### FIELD OF THE INVENTION

The present invention relates, in general, to a method and a system for controlling a feeding length of a wire and more particularly, relates to a method and a system for controlling a feeding length of a solder wire and a detecting system for performing the method.

### BACKGROUND

In the prior art, a solder wire is generally fed forward under a frictional engaging force between the solder wire and a driving wheel connected to an electric motor. The feeding length of the wire is often controlled with an open loop control. For example, the number of revolutions of the electric motor is first calculated according to a predetermined feeding length of the wire, and then the electric motor is started to rotate the driving wheel to feed the wire. When the electric motor runs to the calculated number of revolutions, the electric motor is stopped, and the feeding operation of the wire is finished. Theoretically, since the calculated number of revolutions of the electric motor corresponds to the predetermined feeding length of the wire, the actual feeding length of the wire would be equal to the predetermined feeding length of the wire. However, in practice, unexpected conditions may occur. For example, the driving wheel might slip over the wire or the electric motor might idle. This might cause the actual feeding length of the wire to be inaccurate and not be equal to the predetermined feeding length.

### SUMMARY

The present invention has been made to overcome or alleviate at least one aspect of the above mentioned disadvantages.

Accordingly, it is an object of the present invention to provide a method and a system for accurately controlling a feeding length of a wire.

Accordingly, it is another object of the present invention to provide a simple displacement sensing system capable of accurately sensing the actual feeding length of a wire.

According to an aspect of the present invention, a method for controlling a feeding length of a wire comprises the steps of setting a predetermined feeding length of a wire, feeding the wire along a path of movement, and sensing, at a point along the path of movement of the wire, the passage of the wire. Also included in this method are the steps of calculating, over a predetermined interval, the actual feeding length of the wire that passes the point along the path of movement of the wire, comparing the calculated actual feeding length of the wire with the predetermined feeding length of the wire, and stopping the feeding of the wire when an error between a predetermined feeding length of the wire and the calculated actual feeding length of the wire is zero or is within an allowable range.

According to another aspect of the present invention, a system for controlling the feeding length of a wire comprises a wire guiding mechanism including (a) an inlet through which a wire is received by the system, and (b) an outlet through which the wire leaves the system. This system also includes a driving mechanism that feeds the wire through the system and includes (a) a driving wheel positioned to frictionally engage the wire and feed the wire through the system when the driving wheel rotates, and (b) a driver for rotating the driving wheel. This system further includes a displacement sensing device that senses the actual feeding length of the wire and includes (a) a driven wheel positioned to frictionally engage the wire and rotate when the wire is fed through the system, and (b) a sensor for sensing the number of revolutions of the driven wheel. This system also includes a controller preset with a predetermined feeding length of the wire that calculates the actual feeding length of the wire based on the product of (i) the number of revolutions of the driven wheel of the displacement sensing device sensed by the sensor of the displacement sensing device, and (ii) the perimeter of the driven wheel. The controller also controls the feeding length of the wire based on an error between the predetermined feeding length of the wire and the calculated actual feeding length of the wire with closed loop feedback control until the error becomes zero or within an allowable range.

According to another aspect of the present invention, a displacement sensing system for controlling the feeding length of a wire comprises a displacement sensing device including (a) driven wheel that rotates in response to frictional contact between the perimeter of the driven wheel and a wire moving past the driven wheel, and (b) a sensor for sensing the number of revolutions of the driven wheel over a predetermined interval; and a controller for calculating an actual feeding length of the wire based on (a) the product of the number of revolutions of the driven wheel sensed by the sensor over the predetermined interval, and (b) the perimeter of the driven wheel.

### BRIEF DESCRIPTION OF THE DRAWINGS

The above and other features of the present invention will become more apparent by describing in detail exemplary embodiments thereof with reference to the accompanying drawing, in which:

FIG. 1 is an illustrative perspective view of a wire feeding system according to an exemplary embodiment of the present invention.

### DETAILED DESCRIPTION OF THE EMBODIMENTS OF THE INVENTION

Exemplary embodiments of the present disclosure will be described hereinafter in detail with reference to the attached drawing. The present invention may, however, be embodied in many different forms and should not be construed as being limited to the embodiments set forth herein; rather, these embodiments are provided so that the disclosure of the present invention will be thorough and complete, and will fully convey the concept of the invention to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In an exemplary embodiment of the present invention, the wire feeding system mainly comprises (a) a wire guiding mechanism 110, 120, 130 for guiding a wire 111 to move forward in a straight line, (b) a driving mechanism 200, 210 for driving the wire to move forward, (c) a displacement sensing device 300, 310 for sensing an actual feeding length of the wire, (d) an installation frame 100 for fixing various members thereon, and (e) a controller 400 for controlling the operation of the entire system.

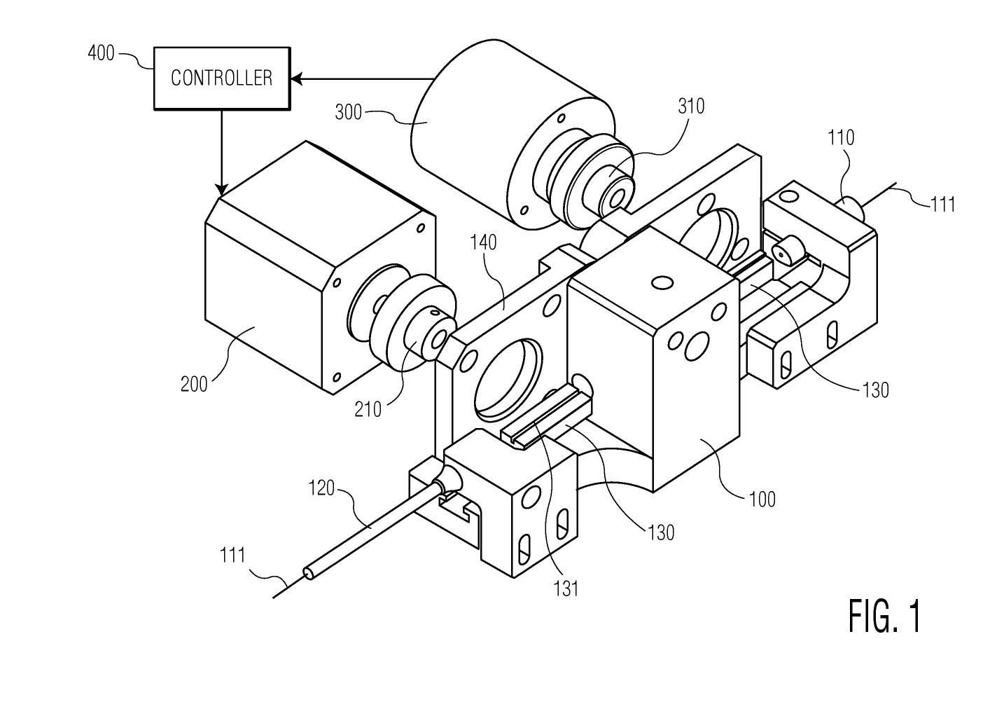

In the illustrated embodiment of FIG. 1, the wire guiding mechanism mainly comprises an inlet tube 110, an outlet tube 120 and a groove member 130. The inlet tube 110 and the outlet tube 120 are mounted, respectively, at a front end and a rear end of the installation frame 100. The groove member 130 is mounted on the installation frame 100 between the inlet tube 110 and the outlet tube 120. With the above configuration, the wire may pass through the inlet tube 110, a groove 131 formed in the groove member 130 and the outlet tube 120 as the wire is fed.

In an exemplary embodiment of the present invention, as shown in FIG. 1, the driving mechanism mainly comprises a driver 200 and a driving wheel 210. The driving wheel 210 frictionally engages the wire 111. As a result, the wire can be fed forward under the frictional engaging force between the wire 111 and the driving wheel 210. The driving wheel 210 is connected to the driver 200. The driver 200 rotates the driving wheel 210 so as to feed the wire.

As shown in FIG. 1, in an exemplary embodiment of the present invention, the displacement sensing device mainly comprises a driven wheel 310 and a sensor 300 for sensing the number of revolutions of the driven wheel 310. The driven wheel 310 frictionally engages the wire 111 and rotates under the frictional engaging force therebetween while the wire is being fed. The sensor 300 senses the number of revolutions of the driven wheel 310, converts the number of revolutions of the driven wheel 310 into an electrical signal, and transmits the electrical signal to the controller 400. Thereby, the controller can calculate, over a predetermine interval, the actual feeding length of the wire based on the product of the number of revolutions of the driven wheel 310 sensed by the sensor 300 and a perimeter of the driven wheel 310.

As shown in FIG. 1, the driver 200 and the sensor 300 are fixedly mounted on a vertical side wall 140 of the installation frame 100.

In an exemplary embodiment, as shown in FIG. 1, at least a part of the outer circumferential surface of the wire 111 is exposed at both ends of the groove of the groove member 130, such that the circumferential surfaces of the driving wheel 210 and the driven wheel 310 may press against the exposed outer surface of the wire and frictionally engage the wire.

In an exemplary embodiment of the present invention, the driver 200 can be an electric motor, with the driving wheel 210 coaxially mounted on an output shaft of the electric motor.

In an exemplary embodiment of the present invention, the sensor 300 can be a rotary optical encoder or a rotary electrical encoder, with the driven wheel 310 coaxially mounted on an input shaft of the encoder.

In the illustrated embodiment of FIG. 1, the axis of the output shaft of the electric motor 200 is arranged to be parallel to the axis of the input shaft of the encoder 300; and the axis of the wire 111 is perpendicular to the axes of the output shaft of the electric motor 200 and the input shaft of the encoder 300.

In an exemplary embodiment of the present invention, the controller 400 may comprise a Programmable Logic Controller, Industrial Computer or Personal Computer.

The following are descriptions of embodiments of methods for controlling the feeding length of a wire according to the present invention in which the wire 111 is frictionally engaged with and fed by a driving wheel 210 mounted on a driver 200.

The first embodiment comprises steps of:

S10: providing a displacement sensing device comprising a driven wheel 310 and a sensor 300 for sensing the number of revolutions of the driven wheel 310, the driven wheel 310 being in frictional engagement with the wire 111 and rotated under a friction engaging force therebetween as the wire is fed;

S20: starting the driver 200 to rotate the driving wheel 210, so that the wire 111 is fed forward and the driven wheel 310 is rotated as the wire is fed;

S30: calculating an actual feeding length of the wire 111 based on the product of the number of revolutions of the driven wheel 310 sensed by the sensor 300 over a predetermined interval and the perimeter of the driven wheel 310; and

S40: controlling the feeding length of the wire 111 based on an error between a predetermined feeding length of the wire and the calculated actual feeding length of the wire with closed loop feedback control, namely controller 40 controlling driver 200, until the error becomes zero or within an allowable range.

In an exemplary embodiment of the present invention, the allowable range may be a range of 0 to 0.1 mm, preferably, a range of 0 to 0.05 mm, more preferably, a range of 0 to 0.01 mm.

The second embodiment comprises steps of:

S100: providing a displacement sensing device comprising a driven wheel 310 and a sensor 300 for sensing the number of revolutions of the driven wheel 310, the driven wheel 310 being in frictional engagement with the wire 111 and rotated under a frictional engaging force therebetween as the wire is fed;

S200: setting a predetermined driving amount (for example, a predetermined number of revolutions of the electric motor 200) for the driver 200 according to a predetermined feeding length of the wire;

S300: starting the driver 200 to rotate the driving wheel 210, so that the wire 111 is fed forward and the driven wheel 310 is rotated as the wire is fed;

S400: stopping the driver 200 when the driver 200 reaches the predetermined driving amount, and calculating an actual feeding length of the wire 111 based on the product of the number of revolutions of the driven wheel 310 sensed by the sensor 300 and the perimeter of the driven wheel 310; and

S500: determining whether an error between the predetermined feeding length of the wire and the calculated actual feeding length of the wire is equal to zero or within an allowable range. If not, starting the driver 200 again and controlling a driving amount of the driver 200 based on the error with closed loop feedback control of controller 400 until the error becomes zero or within the allowable range.

In another exemplary embodiment of the present invention, there is provided a method for controlling a feeding length of a wire, comprising: sensing an actual feeding length of the wire; and controlling the feeding length of the wire based on an error between a predetermined feeding length of the wire and the sensed actual feeding length of the wire with closed loop feedback control until the error becomes zero or within a allowable range.

In an exemplary embodiment of the present invention, the wire may be solder wire, such as metal solder wire or alloy solder wire, for example, tin solder, tin brass solder wire or aluminum brazing wire.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it will be appreciated by those skilled in the art that various changes or modifications may be made in these embodiments without departing from the principles and spirit of the present invention, the scope of which is defined in the claims and their equivalents.

As used herein, an element or step recited in the singular and preceded with the word “a” or “an” should be understood as not excluding plurals of said element or step, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” or “including” an element or a plurality of elements having a particular property may include additional such elements not having that property.

What is claimed is:

1. A method for controlling the feeding length of a wire comprising the steps of:
setting a predetermined feeding length of a wire;
feeding a wire along a path of movement;
sensing, at a point along the path of movement of the wire, the passage of the wire;
calculating, over a predetermined interval, the actual feeding length of the wire that passes the point along the path of movement of the wire;
comparing the calculated actual feeding length of the wire with the predetermined feeding length of the wire; and
stopping the feeding of the wire when an error between a predetermined feeding length of the wire and the calculated actual feeding length of the wire is zero or is within an allowable range.

2. The method according to claim 1 wherein:
(a) revolutions of a rotating component that is in frictional engagement with the wire and is rotated by the passage of the wire sense the passage of the wire and are sensed, and
(b) the calculated actual feeding length of the wire is the product of:
(i) the number of revolutions of the rotating component sensed over the predetermined interval, and
(ii) the perimeter of the rotating component.

3. The method according to claim 2 wherein the allowable range is between 0 to 0.1 mm.

4. A method for controlling a feeding length of a wire comprising steps of:
providing a wire;
providing a driving mechanism comprising a driving wheel and a driver for rotating the driving wheel;
providing a displacement sensing device comprising a driven wheel and a sensor for sensing the number of revolutions of the driven wheel;
positioning the driving wheel of the driving mechanism, so that the driving wheel frictionally engages the wire and feeds the wire when the driver of the driving mechanism starts and the driving wheel rotates;
positioning the driven wheel of the displacement sensing device, so that the driven wheel frictionally engages the wire and rotates when the wire is fed;
starting the driver of the driving mechanism to rotate the driving wheel of the driving mechanism, so that the wire is fed forward and the driven wheel of the displacement sensing device is rotated as the wire is fed;
calculating an actual feeding length of the wire based on the product of:
(a) the number of revolutions of the driven wheel of the displacement sensing device sensed by the sensor of the displacement sensing device, and
(b) the perimeter of the driven wheel; and
controlling the feeding length of the wire based on an error between a predetermined feeding length of the wire and the calculated actual feeding length of the wire with closed loop feedback control until the error becomes zero or within an allowable range.

5. The method according to claim 4 wherein the allowable range is between 0 to 0.1 mm.

6. The method according to claim 4 wherein:
(a) the driver of the driving mechanism includes an electric motor, and
(b) the driving wheel of the driving mechanism is coaxially mounted on an output shaft of the electric motor.

7. The method according to claim 4 wherein:
(a) the sensor of the displacement sensing device includes one of a rotary optical encoder and a rotary electrical encoder, and
(b) the driven wheel of the displacement sensing device is coaxially mounted on an input shaft of the encoder.

8. The method according to claim 4 wherein:
(a) the driver of the driving mechanism includes an electric motor,
(b) the driving wheel of the driving mechanism is coaxially mounted on an output shaft of the electric motor,
(c) the sensor of the displacement sensing device includes one of a rotary optical encoder and a rotary electrical encoder, and
(d) the driven wheel of the displacement sensing device is coaxially mounted on an input shaft of the encoder.

9. The method according to claim 8 wherein
(a) the axis of the output shaft of the electric motor is parallel to the axis of the input shaft of the encoder; and
(b) an axis of the wire is perpendicular to the axes of the output shaft of the electric motor and the input shaft of the encoder.

10. A displacement sensing system for controlling a feeding length of a wire comprising:
a displacement sensing device including:
(a) a driven wheel that rotates in response to frictional contact between the perimeter of the driven wheel and a wire moving past the driven wheel, and
(b) a sensor for sensing the number of revolutions of the driven wheel over a predetermined interval; and
a controller for calculating an actual feeding length of the wire based on:
(a) the product of the number of revolutions of the driven wheel sensed by the sensor over the predetermined interval, and
(b) the perimeter of the driven wheel.

11. The displacement sensing system according to claim 10 wherein:
(a) the sensor is one of a rotary optical encoder and a rotary electrical encoder, and
(b) the driven wheel is coaxially mounted on an input shaft of the encoder.

12. A method for controlling a feeding length of a wire comprising:
providing a wire to be fed along a path of movement;
providing a driving mechanism comprising a driving wheel and a driver for rotating the driving wheel;
positioning the driving wheel of the driving mechanism in frictional engagement with the wire, so that the driving wheel feeds the wire under the frictional engaging force between the driving wheel and the wire when the driving wheel is rotated;
setting a predetermined driving amount for the driver according to a predetermined feeding length of the wire;
providing a displacement sensing device comprising a driven wheel and a sensor for sensing the number of revolutions of the driven wheel;
positioning the driven wheel of the displacement sensing device in frictional engagement with a wire being fed, so that the driven wheel rotates under the frictional engaging force between the driven wheel and the wire as the wire is fed;
starting the driver of the driving mechanism to rotate the driving wheel, so that the wire is fed forward and the driven wheel of the displacement sensing device is rotated as the wire is fed;
stopping the driver of the driving mechanism when the driver runs to the predetermined driving amount;
calculating an actual feeding length of the wire based on the product of:
(a) the number of revolutions of the driven wheel of the displacement sensing device sensed by the sensor, and (b) the perimeter of the driven wheel;
determining whether an error between the predetermined feeding length of the wire and the calculated actual feeding length of the wire is equal to zero or within an allowable range;
restarting the driver of the driving mechanism if there is error between the predetermined feeding length of the wire and the calculated actual feeding length of the wire that is not equal to zero or not within an allowable range; and
controlling a driving amount of the driver of the driving mechanism based on the error with closed loop feedback control until the error becomes zero or within the allowable range.

13. A method for controlling a feeding length of a wire, comprising:
sensing an actual feeding length of a wire; and
controlling the feeding length of the wire based on an error between a predetermined feeding length of the wire and the sensed actual feeding length of the wire with closed loop feedback control until the error becomes zero or within an allowable range.

14. A system for controlling a feeding length of a wire comprising:
a wire guiding mechanism including:
(a) an inlet through which a wire enters the system, and (b) an outlet through which the wire leaves the system;
a driving mechanism that feeds the wire through the system and includes:
(a) a driving wheel positioned to frictionally engage the wire and feed the wire through the system when the driving wheel rotates, and
(b) a driver for rotating the driving wheel;
a displacement sensing device that senses the actual feeding length of the wire and includes:
(a) a driven wheel positioned to frictionally engage the wire and rotate when the wire is fed through the system, and
(b) a sensor for sensing the number of revolutions of the driven wheel; and
a controller preset with a predetermined feeding length of the wire that:
(a) calculates the actual feeding length of the wire based on the product of:
(i) the number of revolutions of the driven wheel of the displacement sensing device sensed by the sensor of the displacement sensing device, and
(ii) the perimeter of the driven wheel; and
(b) controls the feeding length of the wire based on an error between the predetermined feeding length of the wire and the calculated actual feeding length of the wire with closed loop feedback control until the error becomes zero or within an allowable range.

15. The system according to claim 14 wherein:
(a) the driver of the driving mechanism includes an electric motor,
(b) the driving wheel of the driving mechanism is coaxially mounted on an output shaft of the electric motor,
(c) the sensor of the displacement sensing device includes one of a rotary optical encoder and a rotary electrical encoder, and
(d) the driven wheel of the displacement sensing device is coaxially mounted on an input shaft of the encoder.

16. The system according to claim 15 wherein the allowable range is between 0 to 0.1 mm.

17. The system according to claim 16 wherein:
(a) the axis of the output shaft of the electric motor is parallel to the axis of the input shaft of the encoder; and
(b) the axis of the wire, as it is fed through the system, is perpendicular to the axes of the output shaft of the electric motor and the input shaft of the encoder.
